(19) United States
(12) Patent Application Publication
(10) Pub. No.: US 2026/0279389 A1
(43) Pub. Date: Sep. 17, 2026

(54) MAGNETIC SENSOR AND MAGNETIC RECORDING DEVICE

(71) Applicants: Kabushiki Kaisha Toshiba, Kawasaki-shi (JP); Toshiba Electronic Devices & Storage Corporation, Kawasaki-shi (JP)

(72) Inventors: Junki NUMATA, Kawasaki Kanagawa (JP); Yuji NAKAGAWA, Kawasaki Kanagawa (JP); Ryo OSAMURA, Kawasaki Kanagawa (JP); Kosuke KURIHARA, Yokohama Kanagawa (JP); Yuki SAITO, Fuchu Tokyo (JP)

(21) Appl. No.: 19/530,894

(22) Filed: Feb. 5, 2026

(30) Foreign Application Priority Data
Mar. 11, 2025 (JP) 2025-038345

(51) Int. Cl. G11B 5/31

(52) U.S. Cl. CPC G11B 5/31

(57) ABSTRACT

According to one embodiment, a magnetic sensor includes a first conductive portion, a second conductive portion, a sensor portion, a temperature control element, and a controller. The sensor portion includes a first magnetic member provided between the first conductive portion and the second conductive portion. A direction from the temperature control element to the sensor portion includes a component of a second direction crossing a first direction from the first conductive portion to the second conductive portion. The controller is configured to change a temperature of the temperature control element.

### CROSS-REFERENCE TO RELATED APPLICATIONS

This application is based upon and claims the benefit of priority from Japanese Patent Application No.2025-038345, filed on Mar. 11, 2025; the entire contents of which are incorporated herein by reference.

### FIELD

Embodiments described herein relate generally to a magnetic sensor and a magnetic recording device.

### BACKGROUND

A magnetic head including a magnetic sensor is used to reproduce information recorded on a magnetic recording medium such as a hard disk drive (HDD). Improved characteristics of the magnetic sensor are desired.

### BRIEF DESCRIPTION OF THE DRAWINGS

FIG. 1 is a schematic diagram illustrating a magnetic sensor according to a first embodiment;

FIGS. 2A and 2B are schematic diagrams illustrating the operation of the magnetic sensor according to the first embodiment;

FIG. 3A and 3B are schematic diagrams illustrating magnetic sensors according to the first embodiment;

FIG. 4 is a schematic diagram illustrating a magnetic sensor according to the first embodiment;

FIG. 5 is a schematic diagram illustrating a magnetic sensor according to the first embodiment;

FIG. 6 is a schematic diagram illustrating a magnetic sensor according to the first embodiment;

FIG. 7 is a schematic diagram illustrating a magnetic sensor according to the first embodiment;

FIGS. 8A and 8B are schematic diagrams illustrating a magnetic sensor according to the first embodiment;

FIGS. 9A and 9B are schematic diagrams illustrating a magnetic sensor according to the first embodiment;

FIGS. 10A and 10B are schematic diagrams illustrating a magnetic sensor according to a second embodiment;

FIGS. 11A and 11B are schematic diagrams illustrating a magnetic sensor according to the second embodiment;

FIGS. 12A and 12B are schematic diagrams illustrating a magnetic sensor according to the second embodiment;

FIGS. 13A and 13B are schematic diagrams illustrating a magnetic sensor according to the second embodiment;

FIG. 14 is a schematic diagram illustrating a magnetic sensor according to a third embodiment;

FIG. 15 is a schematic diagram illustrating a magnetic sensor according to the third embodiment;

FIG. 16 is a schematic diagram illustrating a magnetic sensor according to the third embodiment;

FIGS. 17A and 17B are schematic diagrams illustrating magnetic sensors according to a fourth embodiment;

FIG. 18 is a schematic cross-sectional view illustrating an application of the magnetic sensor according to the embodiment;

FIG. 19 is a schematic perspective view illustrating a magnetic recording device according to an embodiment;

FIG. 20 is a schematic perspective view illustrating a magnetic recording device according to the embodiment;

FIG. 21 is a schematic perspective view illustrating a part of a magnetic recording device according to an embodiment;

FIG. 22 is a schematic perspective view illustrating the magnetic recording device according to the embodiment; and

FIGS. 23A and 23B are schematic perspective views illustrating a part of the magnetic recording device according to the embodiment.

### DETAILED DESCRIPTION

According to one embodiment, a magnetic sensor includes a first conductive portion, a second conductive portion, a sensor portion, a temperature control element, and a controller. The sensor portion includes a first magnetic member provided between the first conductive portion and the second conductive portion. A direction from the temperature control element to the sensor portion includes a component of a second direction crossing a first direction from the first conductive portion to the second conductive portion. The controller is configured to change a temperature of the temperature control element.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

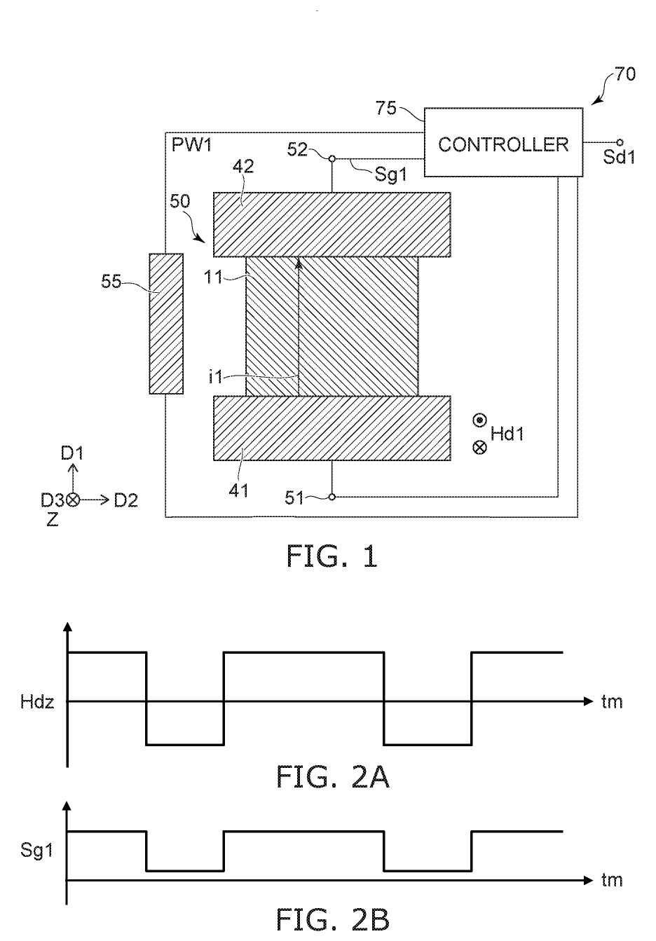

FIG. 1 is a schematic diagram illustrating a magnetic sensor according to a first embodiment.

As shown in FIG. 1, a magnetic sensor 70 according to the embodiment includes a first conductive portion 41, a second conductive portion 42, a sensor portion 50, a temperature control element 55, and a controller 75.

The sensor portion 50 includes a first magnetic member 11 and a temperature control element 55. The first magnetic member 11 is provided between the first conductive portion 41 and the second conductive portion 42.

A direction from the first conductive portion 41 to the second conductive portion 42 is defined as a first direction D1. A direction from the temperature control element 55 to the sensor portion 50 is along a second direction D2 crossing the first direction D1. The second direction D2 may be perpendicular to the first direction D1.

The controller 75 is configured to change the temperature of the temperature control element 55. By changing the temperature of the temperature control element 55, a first signal Sg1 is generated between the first conductive portion 41 and the second conductive portion 42. The first signal Sg1 changes according to a target magnetic field Hd1. The controller 75 can detect the target magnetic field Hd1 by detecting the first signal Sg1. The controller 75 can detect the target magnetic field Hd1 with high sensitivity, for example. For example, a detection result with low noise can be obtained. According to the embodiment, a magnetic sensor can be provided that allows for improved characteristics.

The first signal Sg1 according to the target magnetic field Hd1 is considered to be based on, for example, the Nernst effect. In one example, the temperature control element 55 may be a conductive member (for example, a heater). The controller 75 supplies a first power PW1 to the temperature control element 55. The first power PW1 increases the temperature of the temperature control element 55. The increase in temperature causes a temperature distribution in the sensor portion 50. The sensor portion 50 has a temperature gradient having a component in the second direction D2. An interaction between the temperature gradient and the target magnetic field Hd1 results in the first signal Sg1 that changes according to the change in the target magnetic field Hd1. A highly sensitive detection result is obtained.

In another example, the temperature control element 55 is a Peltier element. The controller 75 supplies a current (first power PW1) to the temperature control element 55. Depending on the orientation of the current, the temperature of the temperature control element 55 increases or decreases. For example, a direction from the temperature control element 55 to the sensor portion 50 includes a component in the second direction D2. An increase or a decrease in temperature causes a temperature distribution in the sensor portion 50. The sensor portion 50 has a temperature gradient having a component in the second direction D2. An interaction between the temperature gradient and the target magnetic field Hd1 produces the first signal Sg1 that changes in response to changes in the target magnetic field Hd1. A highly sensitive detection result is obtained.

As described above, the first signal Sg1 changes according to the component of the target magnetic field Hd1 in the third direction D3. The third direction D3 crosses a plane including the first direction D1 and the second direction D2. The third direction D3 may be perpendicular to the first direction D1 and the second direction D2.

The first magnetic member 11 may include, for example, Co₂MnGa, Co₂MnAl, or Co₃Sn₂S₂. A highly sensitive first signal Sg1 is easily obtained.

As described above, in the embodiment, the controller 75 is configured to detect the first signal Sg1 generated between the first conductive portion 41 and the second conductive portion 42. The controller 75 may output a detection signal Sd1 related to the first signal Sg1. For example, the controller 75 may be configured to output the detection signal Sd1 obtained by processing the first signal Sg1. The processing may include various types of processing, such as amplification, noise removal, and AD conversion.

As shown in FIG. 1, the sensor portion 50 may include a first terminal 51 and a second terminal 52. The first terminal 51 is electrically connected to the first conductive portion 41. The second terminal 52 is electrically connected to the second conductive portion 42. The controller 75 is electrically connected to these terminals.

The controller 75 may supply a first current i1 to the first magnetic member 11. The temperature of the sensor portion 50 may be increased or controlled by the first current i1.

FIGS. 2A and 2B are schematic diagrams illustrating the operation of the magnetic sensor according to the first embodiment.

The horizontal axis of these diagrams is time tm. The vertical axis of FIG. 2A is a component Hdz along the third direction D3 of the target magnetic field Hd1. The vertical axis of FIG. 2B is the first signal Sg1.

As shown in FIG. 2A, the component Hdz along the third direction D3 of the target magnetic field Hd1 changes. For example, the polarity of the component Hdz changes in response to a change in the orientation of the target magnetic field Hd1.

As shown in FIG. 2B, the first signal Sg1 changes in conjunction with changes in the component Hdz. In this example, the polarity of the changing component of the first signal Sg1 is the same as the polarity of the target magnetic field Hd1. In the embodiment, the polarity of the changing component of the first signal Sg1 may be different from the polarity of the target magnetic field Hd1.

In the example of FIG. 2B, the first signal Sg1 includes a DC component. In a case where the first current i1 is not supplied to the first magnetic member 11, the first signal Sg1 may not include a DC component.

In the embodiment, the first conductive portion 41 and the second conductive portion 42 may function as a shield, for example. The first conductive portion 41 and the second conductive portion 42 may include at least one selected from the group consisting of Ni and Fe, for example.

The first magnetic member 11 includes at least one selected from the group consisting of, for example, Co, Co₂MnGa, Co₂MnAl, Co₃Sn₂S₂, CoFeB, FePt, Fe, FePd, FeGa, FeAl, MnGa, Mn₂Ga, Mn₃Sn, Mn₃Ge, Mn₃Ga, Ni, NiPd, NiFe, Nd₅Mn₂O₇, RuO₂, MnTe, CrSb, FeSb₂, KRu₄O₈, and Mn₅Si₃. A highly sensitive first signal Sg1 is easily obtained.

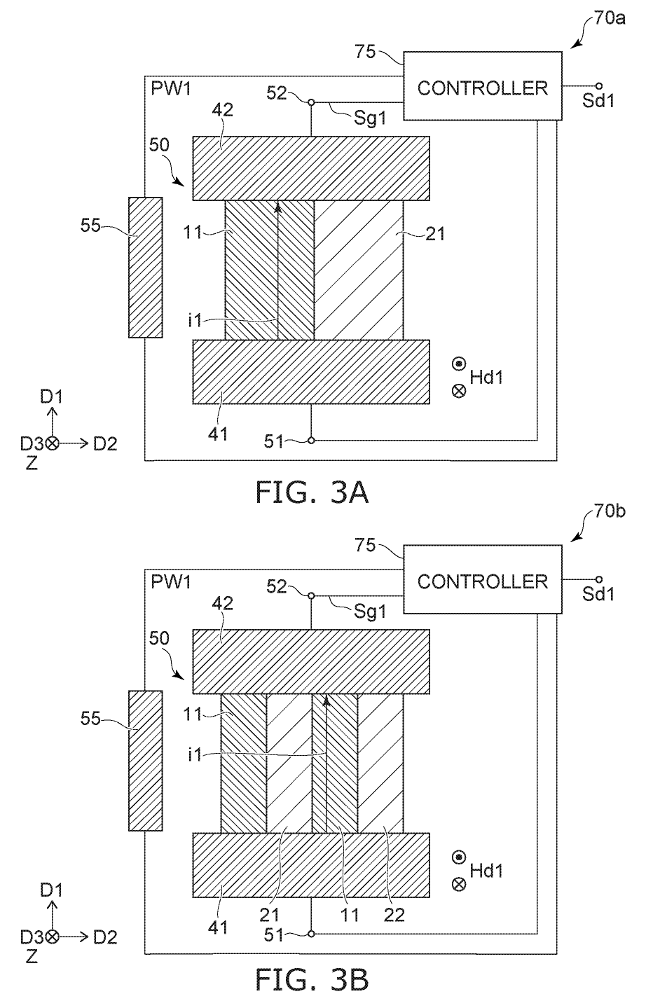

FIG. 3A and 3B are schematic diagrams illustrating magnetic sensors according to the first embodiment.

As shown in FIG. 3A, in a magnetic sensor 70a according to the embodiment, the sensor portion 50 includes a first non-magnetic member 21. The configuration of the magnetic sensor 70a except for this may be the same as the configuration the magnetic sensor 70.

In the magnetic sensor 70a, the first non-magnetic member 21 is provided between the first conductive portion 41 and the second conductive portion 42. A direction from the first magnetic member 11 to the first non-magnetic member 21 crosses the first direction D1. The direction from the first magnetic member 11 to the first non-magnetic member 21 may include a component along the second direction D2.

The first magnetic member 11 may be provided between the temperature control element 55 and the first non-magnetic member 21. The first non-magnetic member 21 may be provided between the temperature control element 55 and the first magnetic member 11.

As shown in FIG. 3B, in the magnetic sensor 70b according to the embodiment, the sensor portion 50 may include a second non-magnetic member 22. The configuration of the magnetic sensor 70b except for this may be the same as the configuration of the magnetic sensor 70.

In the example of magnetic sensor 70b, a plurality of first magnetic members 11 are provided. One of the plurality of first magnetic members 11 is provided between the first non-magnetic member 21 and the second non-magnetic member 22.

The second non-magnetic member 22 may be considered as one of the plurality of first non-magnetic members 21. One of the plurality of first non-magnetic members 21 is provided between one of the plurality of first magnetic members 11 and another one of the plurality of first non-magnetic members 21. One of the plurality of first magnetic members 11 is provided between one of the plurality of first non-magnetic members 21 and another one of the plurality of first non-magnetic members 21. The number of the plurality of first non-magnetic members 21 is arbitrary.

A part of one of the plurality of first magnetic members 11 may be continuous with a part of another one of the plurality of first magnetic members 11. The position at which a part of one of the plurality of first magnetic members 11 is continuous with a part of another one of the plurality of first magnetic members 11 may be arbitrary.

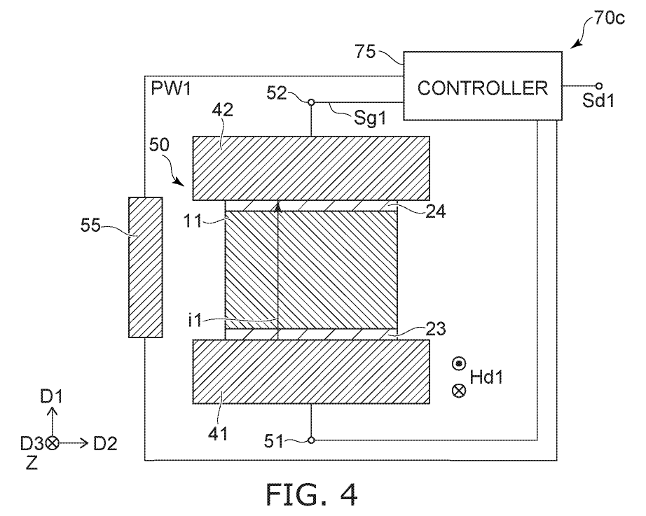

FIG. 4 is a schematic diagram illustrating a magnetic sensor according to the first embodiment.

As shown in FIG. 4, in a magnetic sensor 70c according to the embodiment, the sensor portion 50 includes a third non-magnetic member 23. The configuration of the magnetic sensor 70c except for this may be the same as the configuration of magnetic sensor 70, etc.

The third non-magnetic member 23 is between the first conductive portion 41 and the first magnetic member 11. In the example of magnetic sensor 70c, the sensor portion 50 may include a fourth non-magnetic member 24. The fourth non-magnetic member 24 is between the first magnetic member 11 and the second conductive portion 42.

At least one of the first non-magnetic member 21, the second non-magnetic member 22, the third non-magnetic member 23, or the fourth non-magnetic member 24 includes at least one selected from the group consisting of, for example, Pt, W, Ta, Bi, Cu, Au, Ag, Mo, Nb, Al, Pd, Ru, Ir, Hf, and Rh.

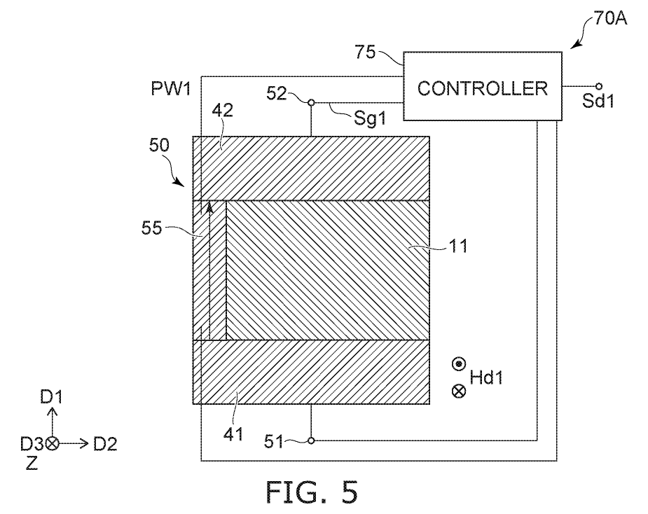

FIG. 5 is a schematic diagram illustrating a magnetic sensor according to the first embodiment.

As shown in FIG. 5, in a magnetic sensor 70A according to the embodiment, the temperature control element 55 is located between a part of the first conductive portion 41 and a part of the second conductive portion 42. The configuration of the magnetic sensor 70A except for this may be the same as the configuration of the magnetic sensor 70.

In the magnetic sensor 70A, a current (first power PW1) may be supplied to the temperature control element 55 via the first conductive portion 41 and the second conductive portion 42.

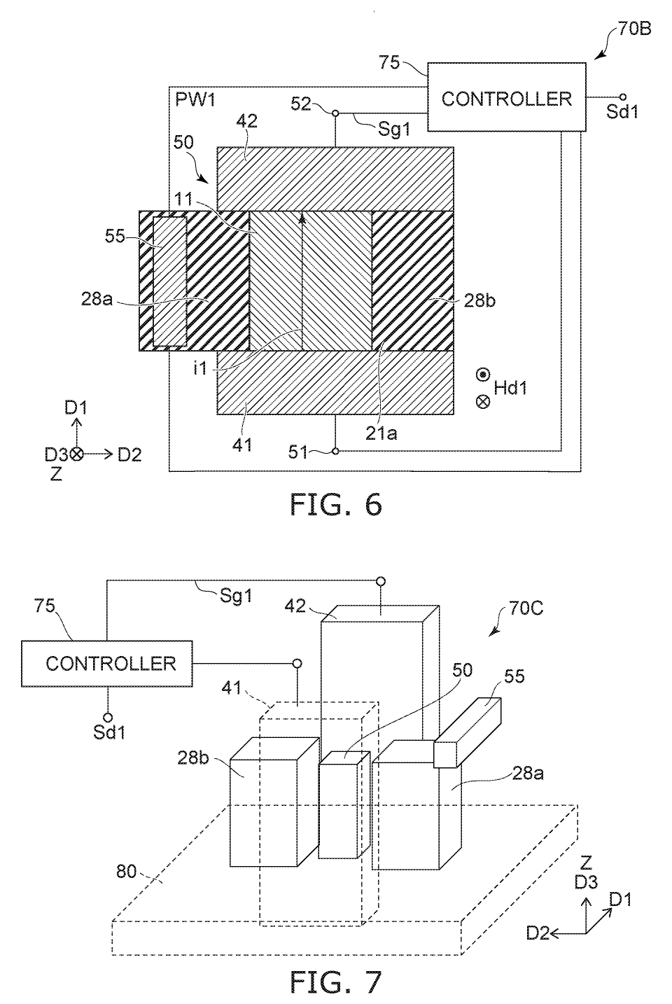

FIG. 6 is a schematic diagram illustrating a magnetic sensor according to the first embodiment.

As shown in FIG. 6, in a magnetic sensor 70B according to the embodiment, the sensor portion 50 includes a first structure 28a and a second structure 28b. The configuration of the magnetic sensor 70B except for this may be the same as the configuration of the magnetic sensor 70, etc.

The position of the first magnetic member 11 in the second direction D2 (first magnetic member position) is between the position of the first structure 28a in the second direction D2 (first structure position) and the position of the second structure 28b in the second direction D2 (second structure position). The first thermal conductivity of the first structure 28a is different from the second thermal conductivity of the second structure 28b.

The difference in thermal conductivity can increase the temperature difference at two different positions in the second direction D2.

The first structure 28a and the second structure 28b may be, for example, insulative. The first structure 28a and the second structure 28b may include, for example, a non-magnetic insulating material. The first structure 28aand the second structure 28b may be in contact with the first magnetic member 11. The first structure 28aand the second structure 28b may include, for example, a non-magnetic conductive material.

For example, the first structure 28a may include at least one selected from the group consisting of Cu, SiC, Al, W, Mo, Au, Ag, AlN, BN, Al₂O₃, and Y₂O₅. The second structure 28bmay include at least one selected from the group consisting of Ta, GaAs, Ti, SiO₂, Si₃N₄, TiO₂, MgO, HfO₂, ZrO₂, and Nb₂O₅.

FIG. 7 is a schematic diagram illustrating a magnetic sensor according to the first embodiment.

As shown in FIG. 7, a magnetic sensor 70C according to the embodiment includes the temperature control element 55. The position of the temperature control element 55 in the magnetic sensor 70C is different from that in the magnetic sensor 70. The configuration of magnetic sensor 70C except for this may be the same as the configuration of magnetic sensor 70, etc.

The direction from the temperature control element 55 to the sensor portion 50 includes a component of the second direction D2. In the magnetic sensor 70C, the direction from the temperature control element 55 to the sensor portion 50 is along the second direction D2 while being inclined with respect to the second direction D2.

For example, the magnetic sensor 70C may be applied to a magnetic head. The sensor portion 50 of the magnetic sensor 70C faces a magnetic recording medium 80. A direction from the magnetic recording medium 80 to the sensor portion 50 is along the third direction D3. For example, the position of the temperature control element 55 in the third direction D3 may be different from the position of the sensor portion 50 in the third direction D3. The position of the sensor portion 50 in the third direction D3 may be between the position of the magnetic recording medium 80 in the third direction D3 and the position of the temperature control element 55 in the third direction D3.

In the magnetic sensor 70C, the first structure 28a and the second structure 28b may be provided. The first thermal conductivity of the first structure 28a is different from the second thermal conductivity of the second structure 28b.

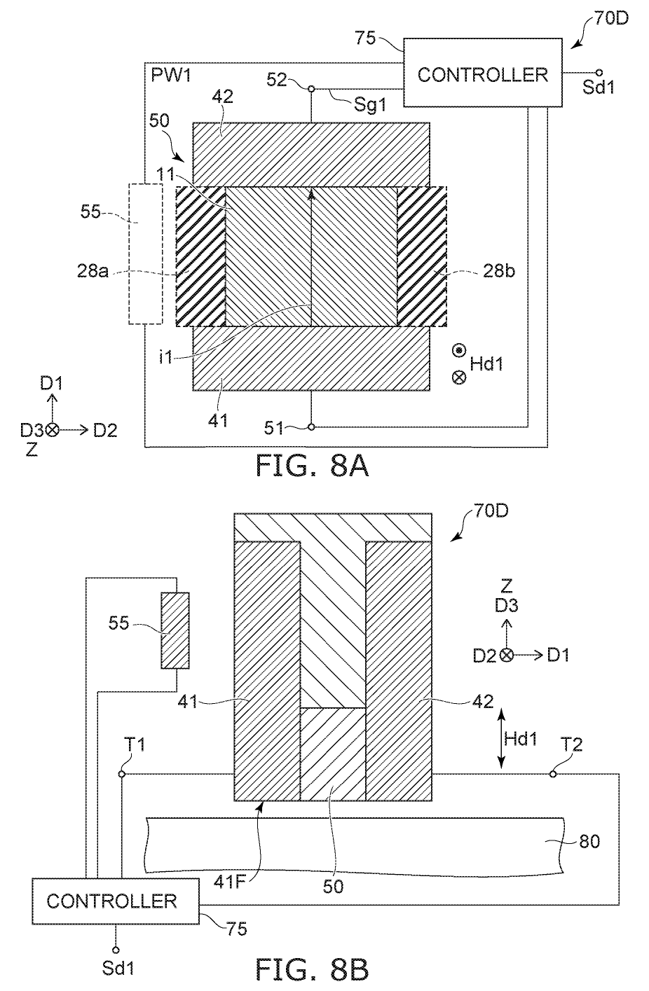

FIGS. 8A and 8B are schematic diagrams illustrating the magnetic sensor according to the first embodiment.

FIGS. 8A is a plan view. FIG. 8B is a cross-sectional view. As shown in FIGS. 8A and 8B, the configuration of the sensor portion 50 in the magnetic sensor 70D according to the embodiment is different from that in the magnetic sensor 70. The configuration of the magnetic sensor 70D except for this may be the same as the configuration of the magnetic sensor 70, etc.

The direction from the temperature control element 55 to the sensor portion 50 includes a component of the second direction D2. In the magnetic sensor 70D, the direction from the temperature control element 55 to the sensor portion 50 is along the second direction D2 while being inclined with respect to the second direction D2.

As shown in FIG. 8B, the magnetic sensor 70D may include an end face 41F in the third direction D3. In a case where the magnetic sensor 70D is applied to a magnetic head, the end face 41F corresponds to the medium-facing face. For example, the position of the first conductive portion 41 in the third direction D3 may be between the position of the end face 41F in the third direction D3 and the position of the temperature control element 55 in the third direction D3.

In a case where the magnetic sensor 70D is applied to a magnetic head, a heater for adjusting the flying height of the magnetic head may be applied as the temperature control element 55. In the embodiment, the temperature control element 55 may be provided separately from the heater for adjusting the flying height of the magnetic head. In the magnetic sensor 70D, at least one of the first structure 28a or the second structure 28b may be provided. The first thermal conductivity of the first structure 28a is different from the second thermal conductivity of the second structure 28b.

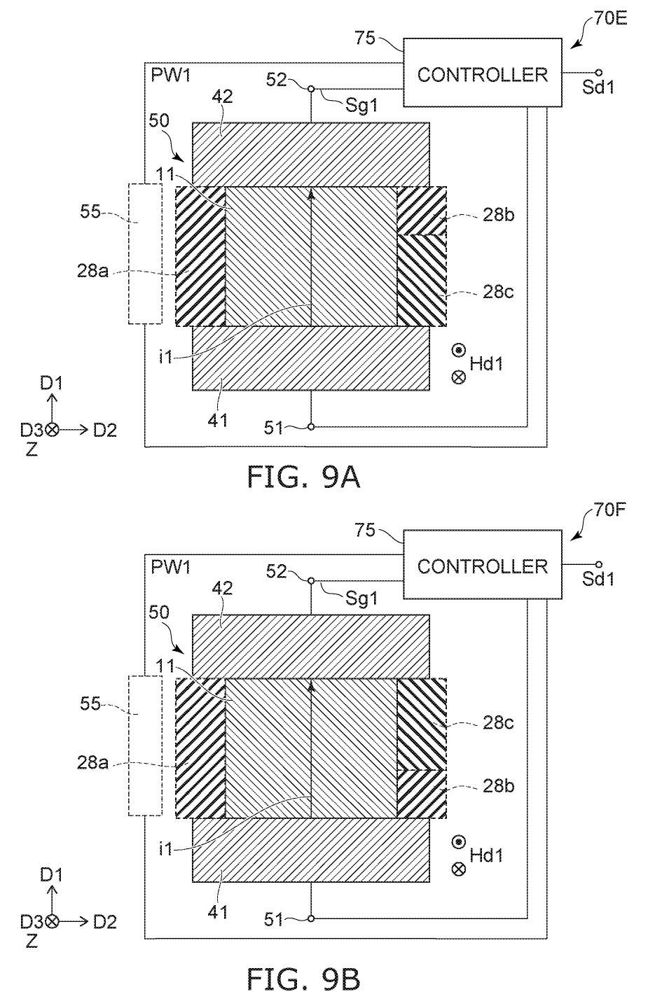

FIGS. 9A and 9B are schematic diagrams illustrating a magnetic sensor according to the first embodiment.

As shown in FIGS. 9A and 9B, in a magnetic sensor 70E and a magnetic sensor 70F according to the embodiment, the sensor portion 50 includes a third structure 28c. The configuration of these magnetic sensors except for this may be the same as the configuration of the magnetic sensor 70D, etc. In the example of magnetic sensor 70E, the third structure 28c is between first conductive portion 41 and second structure 28b. In the example of magnetic sensor 70F, the third structure 28c is between second structure 28b and second conductive portion 42.

A part of the first magnetic member 11 is between a part of the first structure 28a and the second structure 28b. Another part of the first magnetic member 11 is between another part of the first structure 28a and the third structure 28c. The first thermal conductivity of the first structure 28a is different from the second thermal conductivity of the second structure 28b. The third thermal conductivity of the third structure 28c may be the same as the first thermal conductivity of the first structure 28a. These structures may be, for example, insulative. These structures may be in contact with the first magnetic member 11. These structures may include, for example, a non-magnetic conductive member.

### Second Embodiment

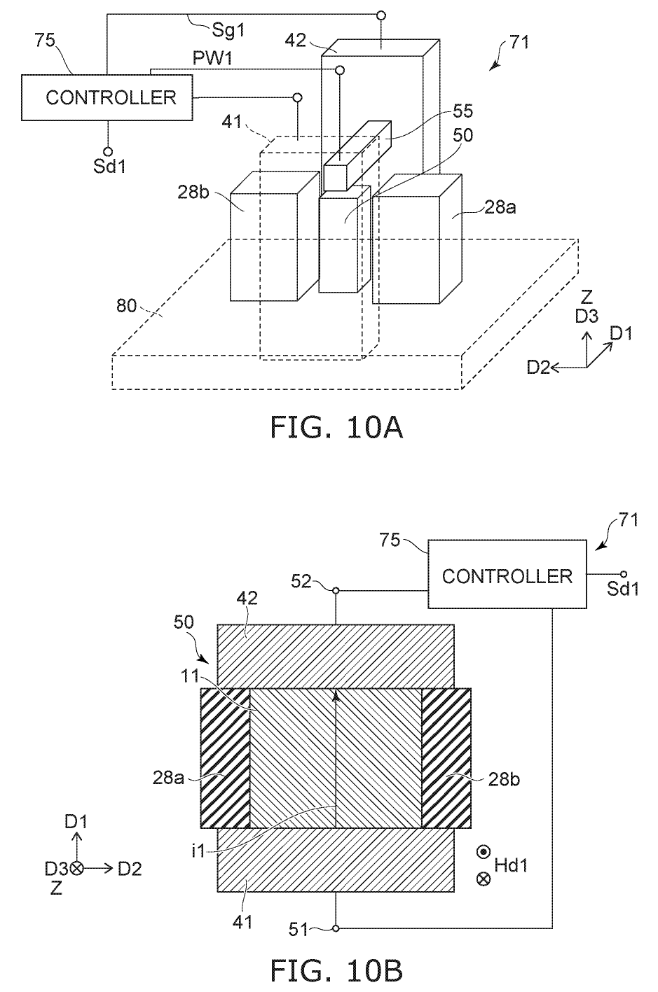

FIGS. 10A and 10B are schematic diagrams illustrating a magnetic sensor according to a second embodiment.

FIG. 10A is a perspective view. FIG. 10B is a plan view. As shown in FIGS. 10A and 10B, a magnetic sensor 71 according to the embodiment includes the first conductive portion 41, the second conductive portion 42, the sensor portion 50, the temperature control element 55, and the controller 75.

The sensor portion 50 includes the first magnetic member 11, the first structure 28a, and the second structure 28b. The first magnetic member 11 is provided between the first conductive portion 41 and the second conductive portion 42. The second direction D2 from the first structure 28a to the second structure 28b crosses the first direction D1 from the first conductive portion 41 to the second conductive portion 42. The second direction D2 may be perpendicular to the first direction D1.

The position of the first magnetic member 11 in the second direction D2 (first magnetic member position) is between the position of the first structure 28a in the second direction D2 (first structure position) and the position of the second structure 28b in the second direction D2 (second structure position). The first thermal conductivity of the first structure 28a is different from the second thermal conductivity of the second structure 28b. The controller 75 is configured to change the temperature of the temperature control element 55.

The controller 75 is configured to detect the first signal Sg1 generated between the first conductive portion 41 and the second conductive portion 42. The first signal Sg1 changes according to the target magnetic field Hd1. For example, the first signal Sg1 changes according to the component of the target magnetic field Hd1 in the third direction D3. The third direction D3 crosses a plane including the first direction D1 and the second direction D2. The controller 75 can detect the target magnetic field Hd1 with high sensitivity, for example. For example, a detection result with low noise can be obtained. According to the embodiment, a magnetic sensor with improved characteristics can be provided.

In the magnetic sensor 71, the relative position between the temperature control element 55 and the sensor portion 50 is arbitrary. In this example, the direction from the first magnetic member 11 to the temperature control element 55 is along the third direction D3. In this example, the third direction D3 is perpendicular to the plane including the first direction D1 and the second direction D2.

In the magnetic sensor 71, for example, the first magnetic member 11 may have the configuration described in relation to the first embodiment.

In the magnetic sensor 71, the temperature control element 55 may include a conductive member (heater) or a Peltier element.

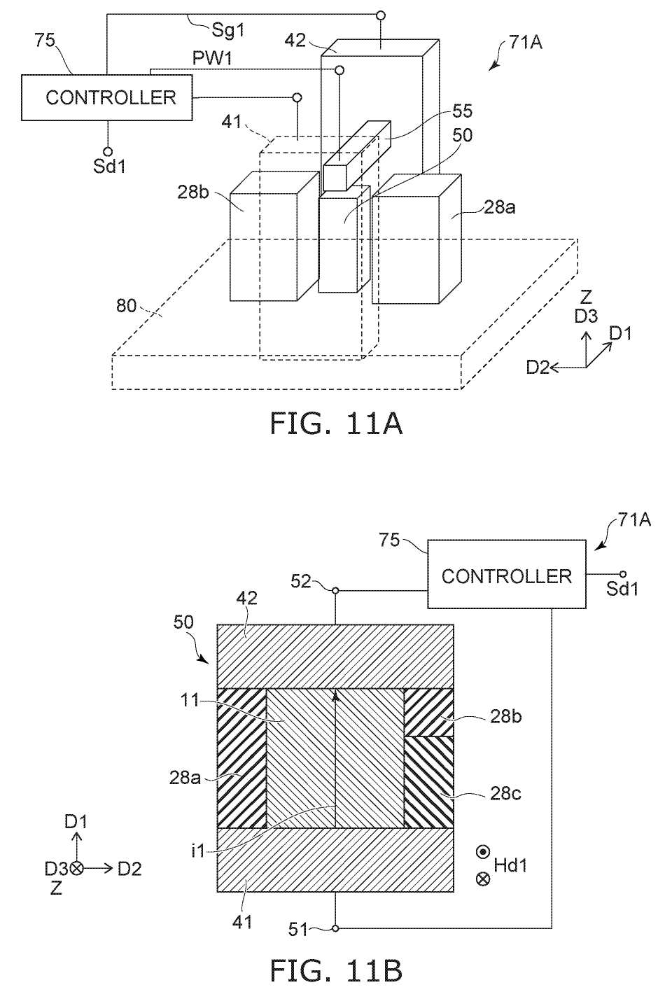

FIGS. 11A and 11B are schematic diagrams illustrating a magnetic sensor according to the second embodiment.

FIG. 11A is a perspective view. FIG. 11B is a plan view. As shown in FIGS. 11A and 11B, in a magnetic sensor 71A according to the embodiment, the sensor portion 50 includes the third structure 28c. The configuration of magnetic sensor 71A except for this may be the same as the configuration of magnetic sensor 71.

In the magnetic sensor 71A, a part of the first magnetic member 11 is between a part of the first structure 28a and the second structure 28b. Another part of the first magnetic member 11 is between another part of the first structure 28a and the third structure 28c. The first thermal conductivity of the first structure 28a is different from the second thermal conductivity of the second structure 28b. For example, the first thermal conductivity of the first structure 28a may be the same as the third thermal conductivity of the third structure 28c. The third thermal conductivity of the third structure 28c may be different from the second thermal conductivity of the second structure 28b. A large temperature difference is easily obtained. These structures may be, for example, insulative. These structures may be in contact with the first magnetic member 11. These structures may be, for example, non-magnetic conductive members.

In the magnetic sensor 71A, the third structure 28c is located between the first conductive portion 41 and the second structure 28b.

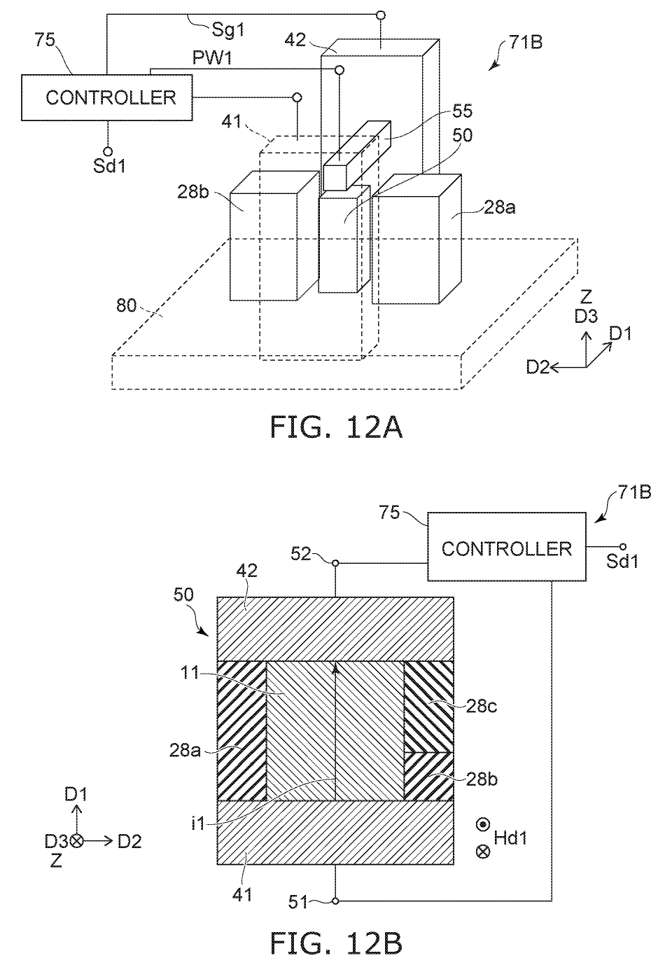

FIGS. 12A and 12B are schematic diagrams illustrating a magnetic sensor according to the second embodiment.

FIG. 12A is a perspective view. FIG. 12B is a plan view. As shown in FIGS. 12A and 12B, in a magnetic sensor 71B according to the embodiment, the sensor portion 50 also includes the third structure 28c. The configuration of the magnetic sensor 71B except for this may be the same as the configuration of the magnetic sensor 71. In the magnetic sensor 71B, the third structure 28c is located between the second structure 28b and the second conductive portion 42.

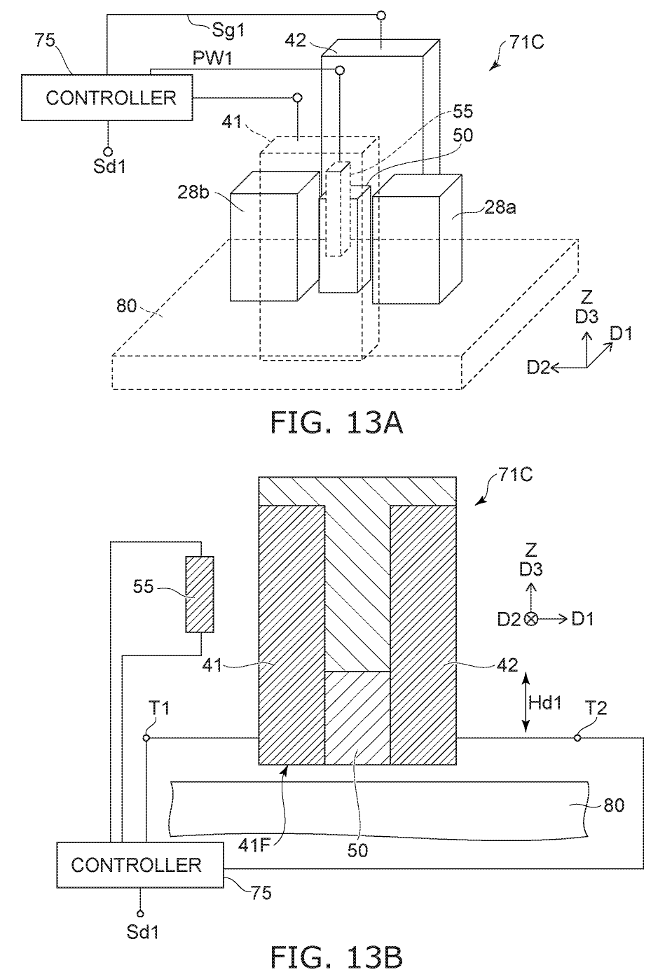

FIGS. 13A and 13B are schematic diagrams illustrating a magnetic sensor according to the second embodiment.

FIG. 13A is a perspective view. FIG. 13B is a side view. As shown in FIGS. 13A and 13B, in a magnetic sensor 71C according to the embodiment, the configuration of temperature control element 55 differs from that in magnetic sensor 71.

In the magnetic sensor 71C, the direction from the temperature control element 55 to the sensor portion 50 includes a component along the first direction D1. In this example, the direction from the temperature control element 55 to the sensor portion 50 includes a component along the first direction D1 while being inclined with respect to the first direction D1.

As described above, in the second embodiment, the direction from the sensor portion 50 to the temperature control element 55 may include at least one component of the first direction D1 and the third direction D3. The third direction D3 crosses a plane including the first direction D1 and the second direction D2.

In a case where the magnetic sensor 71C is applied to a magnetic head, the heater for adjusting the flying height of the magnetic head may be applied as the temperature control element 55. In the embodiment, the temperature control element 55 may be provided separately from the heater for adjusting the flying height of the magnetic head.

In the second embodiment, the sensor portion 50 (and the first magnetic member 11) may have the configuration described in relation to the first embodiment. For example, the sensor portion 50 may include the non-magnetic member described in relation to the first embodiment.

### Third Embodiment

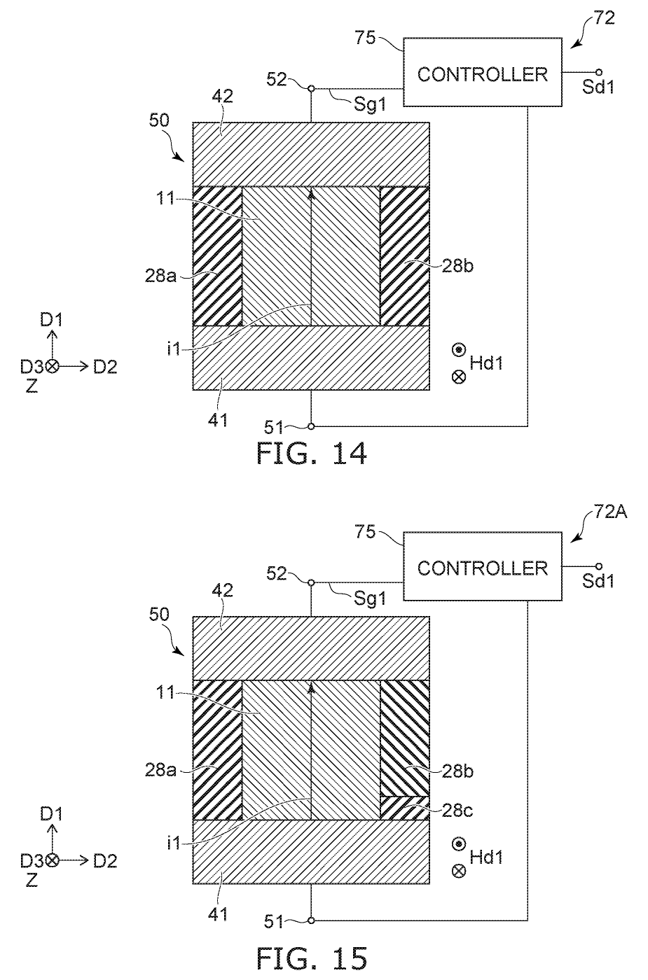

FIG. 14 is a schematic diagram illustrating a magnetic sensor according to a third embodiment.

As shown in FIG. 14, a magnetic sensor 72 according to the embodiment includes the first conductive portion 41, the second conductive portion 42, and the sensor portion 50. The sensor portion 50 includes the first magnetic member 11, the first structure 28a, and the second structure 28b.

The first magnetic member 11 is provided between the first conductive portion 41 and the second conductive portion 42. The second direction D2 from the first structure 28a to the second structure 28b crosses the first direction D1 from the first conductive portion 41 to the second conductive portion 42.

The position of the first magnetic member 11 in the second direction D2 (first magnetic member position) is between the position of the first structure 28a in the second direction D2 (first structure position) and the position of the second structure 28b in the second direction D2 (second structure position). The first thermal conductivity of the first structure 28a is different from the second thermal conductivity of the second structure 28b.

For example, the magnetic sensor 72 may further include a controller 75. The controller 75 is configured to detect the first signal Sg1 generated between the first conductive portion 41 and the second conductive portion 42. The first signal Sg1 changes according to the target magnetic field Hd1.

For example, in the sensor portion 50 including the first magnetic member 11, the temperature may increase due to the current for detecting the first signal Sg1. A temperature gradient is effectively formed by the first structure 28a and the second structure 28b, which have different thermal conductivities. The controller 75 can detect the target magnetic field Hd1 with high sensitivity, for example. For example, a detection result with low noise can be obtained. According to the embodiment, a magnetic sensor capable of improving characteristics can be provided.

In the magnetic sensor 72, the first signal Sg1 changes according to the component of the target magnetic field Hd1 in the third direction D3. The third direction D3 crosses a plane including the first direction D1 and the second direction D2.

In the magnetic sensor 72, for example, the first magnetic member 11 may have the configuration described in relation to the first embodiment.

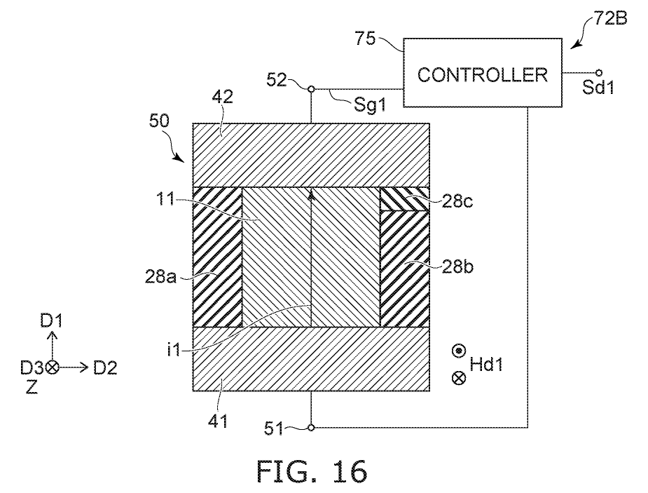

FIGS. 15 and 16 are schematic diagrams illustrating a magnetic sensor according to the third embodiment.

As shown in FIGS. 15 and 16, in a magnetic sensor 72A and a magnetic sensor 72B according to the embodiment, the sensor portion 50 also includes the third structure 28c. The configuration of the magnetic sensor 72A and the magnetic sensor 72B except for this may be the same as the configuration the magnetic sensor 72. In the magnetic sensor 72A, the third structure 28c is located between the first conductive portion 41 and the second structure 28b. In the magnetic sensor 72B, the third structure 28c is located between the second structure 28b and the second conductive portion 42.

### Fourth Embodiment

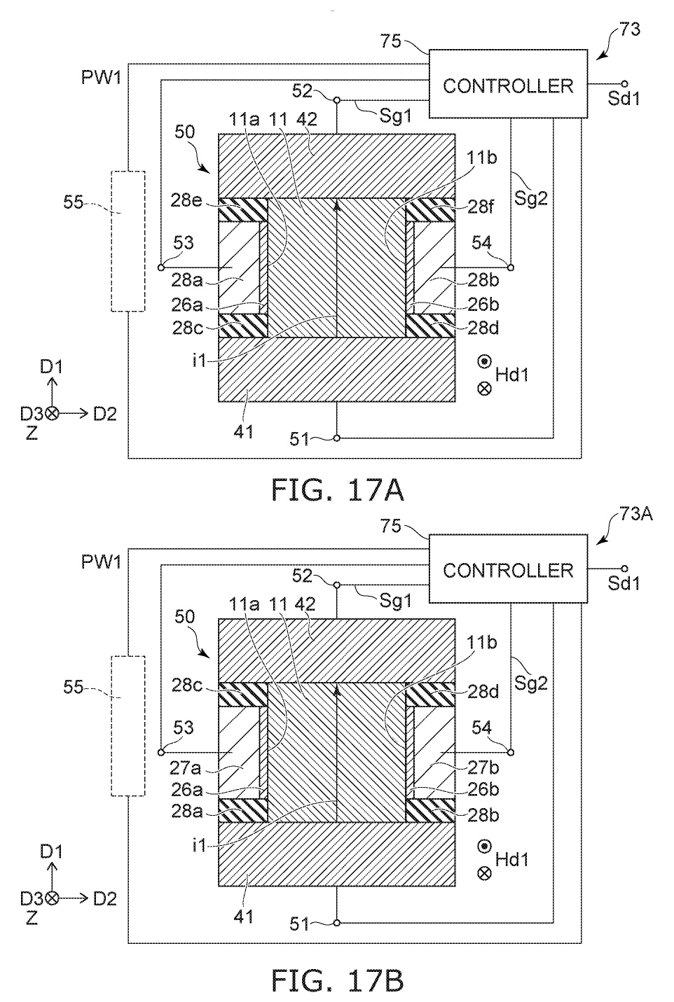

FIGS. 17A and 17B are schematic diagrams illustrating a magnetic sensor according to a fourth embodiment.

As shown in FIG. 17A, a magnetic sensor 73 according to the embodiment includes a first terminal 51, a second terminal 52, a third terminal 53, and a fourth terminal 54. The configuration of the magnetic sensor 73 except for this may be the same as any of the configurations of the magnetic sensors described in relation to the first to third embodiments.

The magnetic sensor 73 includes the first conductive portion 41, the second conductive portion 42, the sensor portion 50, the first terminal 51, the second terminal 52, the third terminal 53, the fourth terminal 54, and the controller 75. The sensor portion 50 includes the first magnetic member 11. The first magnetic member 11 is provided between the first conductive portion 41 and the second conductive portion 42. The first magnetic member 11 includes a first portion 11a and a second portion 11b. A second direction D2 from the first portion 11a to the second portion 11b crosses a first direction D1 from the first conductive portion 41 to the second conductive portion 42.

The first terminal 51 is electrically connected to the first conductive portion 41. The second terminal 52 is electrically connected to the second conductive portion 42. The third terminal 53 is electrically connected to the first portion 11a. The fourth terminal 54 is electrically connected to the second portion 11b.

In this example, the sensor portion 50 includes the first structure 28a and the second structure 28b. These structures are non-magnetic and conductive. The third terminal 53 is electrically connected to the first portion 11a via the first structure 28a. The fourth terminal 54 is electrically connected to the second portion 11b via the second structure 28b. The direction from the first portion 11a to the second portion 11b is along the second direction D2.

The controller 75 includes a first signal Sg1 and a second signal Sg2. The first signal Sg1 is generated between the first terminal 51 and the second terminal 52. The second signal Sg2 is generated between the third terminal 53 and the fourth terminal 54. The first signal Sg1 and the second signal Sg2 change according to the target magnetic field Hd1. For example, at least one of these signals changes according to the component of the target magnetic field Hd1 along the third direction D3. By detecting these signals, the target magnetic field Hd1 can be detected.

In one example, the magnetic sensor 73 includes the temperature control element 55. The controller 75 supplies the first power PW1 to the temperature control element 55. The temperature control element 55 forms a temperature gradient in the sensor portion 50. The above signals change due to the influence of the temperature gradient and the target magnetic field Hd1. The direction from the temperature control element 55 to the first magnetic member 11 is arbitrary.

In one example, the thermal conductivity of the first structure 28a may be different from the thermal conductivity of the second structure 28b. A temperature gradient is formed in the sensor portion 50.

As shown in FIG. 17A, the sensor portion 50 may include a third structure 28c, a fourth structure 28d, a fifth structure 28e, and a sixth structure 28f. The third structure 28cis provided between the first conductive portion 41 and the first structure 28a. The fourth structure 28dis provided between the first conductive portion 41 and the second structure 28b. The fifth structure 28e is provided between the second conductive portion 42 and the first structure 28a. The sixth structure 28f is provided between the second conductive portion 42 and the second structure 28b. The thermal conductivity of the third structure 28c may be different from that of the fourth structure 28d. The thermal conductivity of the fifth structure 28e may be different from the thermal conductivity of the sixth structure 28f. A temperature gradient is formed. The third structure 28c, the fourth structure 28d, the fifth structure 28e, and the sixth structure 28f may be non-magnetic and insulative.

For example, the sensor portion 50 may include a first non-magnetic conductive member 26a and a second non-magnetic conductive member 26b. The first non-magnetic conductive member 26a is provided between the first structure 28a and the first magnetic member 11. The second non-magnetic conductive member 26b is provided between the first magnetic member 11 and the second structure 28b. These non-magnetic conductive members include, for example, at least one selected from the group consisting of Pt, Au, Ag, Cu, W, Ta, Hf, Nb, Mo, Bi, Al, Pd, Ru, Ir, and Rh. Higher accuracy can be obtained with higher sensitivity. The characteristics can be further improved.

As shown in FIG. 17B, in a magnetic sensor 73A according to the embodiment, the sensor portion 50 includes a first non-magnetic conductive portion 27a and a second non-magnetic conductive portion 27b. The configuration of the magnetic sensor 73Aexcept for this may be the same as any of the configurations of the magnetic sensors described above.

In the magnetic sensor 70A, the first magnetic member 11 is provided between the first non-magnetic conductive portion 27a and the second non-magnetic conductive portion 27b. The first non-magnetic conductive portion 27ais connected to the first portion 11a. The second non-magnetic conductive portion 27bis connected to the second portion 11b. The third terminal 53 is electrically connected to the first portion 11a via the first non-magnetic conductive portion 27a. The fourth terminal 54 is electrically connected to the second portion 11b via the second non-magnetic conductive portion 27b. The direction from the first non-magnetic conductive portion 27a to the second non-magnetic conductive portion 27b is along the second direction D2.

The thermal conductivity of the first non-magnetic conductive portion 27a may be different from the thermal conductivity of the second non-magnetic conductive portion 27b. A temperature gradient is formed.

As shown in FIG. 17B, the sensor portion 50 may include the first structure 28a, the second structure 28b, the third structure 28c, and the fourth structure 28d. The first structure 28ais provided between the first conductive portion 41 and the first non-magnetic conductive portion 27a. The second structure 28bis provided between the first conductive portion 41 and the second non-magnetic conductive portion 27b. The third structure 28cis provided between the second conductive portion 42 and the first non-magnetic conductive portion 27a. The fourth structure 28dis provided between the second conductive portion 42 and the second non-magnetic conductive portion 27b. The thermal conductivity of the first structure 28amay be different from the thermal conductivity of the second structure 28b. The thermal conductivity of the third structure 28cmay be different from the thermal conductivity of the fourth structure 28d. A temperature gradient is formed. The first structure 28a, the second structure 28b, the third structure 28c and the fourth structure 28d may be non-magnetic and insulative.

For example, the sensor portion 50 may include the first non-magnetic conductive member 26a and the second non-magnetic conductive member 26b. The first non-magnetic conductive member 26a is provided between the first non-magnetic conductive portion 27a and the first magnetic member 11. The second non-magnetic conductive member 26b is provided between the first magnetic member 11 and the second non-magnetic conductive portion 27b. These non-magnetic conductive members include, for example, at least one selected from the group consisting of Pt, Au, Ag, Cu, W, Ta, Hf, Nb, Mo, Bi, Al, Pd, Ru, Ir, and Rh. Higher sensitivity and higher accuracy can be obtained. The characteristics can be further improved. In the magnetic sensor 73 or the magnetic sensor 73A, the first non-magnetic conductive member 26a and the second non-magnetic conductive member 26b are provided as necessary and may be omitted.

The magnetic sensor 73A may include the temperature control element 55. The controller 75 supplies the first power PW1 to the temperature control element 55. A temperature gradient is formed in the sensor portion 50 by the temperature control element 55. The above signal changes due to the influence of the temperature gradient and the target magnetic field Hd1. The direction from the temperature control element 55 to the first magnetic member 11 is arbitrary.

In the magnetic sensor 73 and the magnetic sensor 73A, the first magnetic member 11 may have the configuration of the first magnetic member 11 described in relation to the first embodiment.

In the magnetic sensor 73 or the magnetic sensor 73A, the first structure 28a may include at least one selected from the group consisting of, for example, Cu, SiC, Al, W, Mo, Au, Ag, AlN, BN, Al₂O₃, and Y₂O₅. The second structure 28b may include at least one selected from the group consisting of, for example, Ta, GaAs, Ti, SiO₂, Si₃N₄, TiO₂, MgO, HfO₂, ZrO₂, and Nb₂O₅.

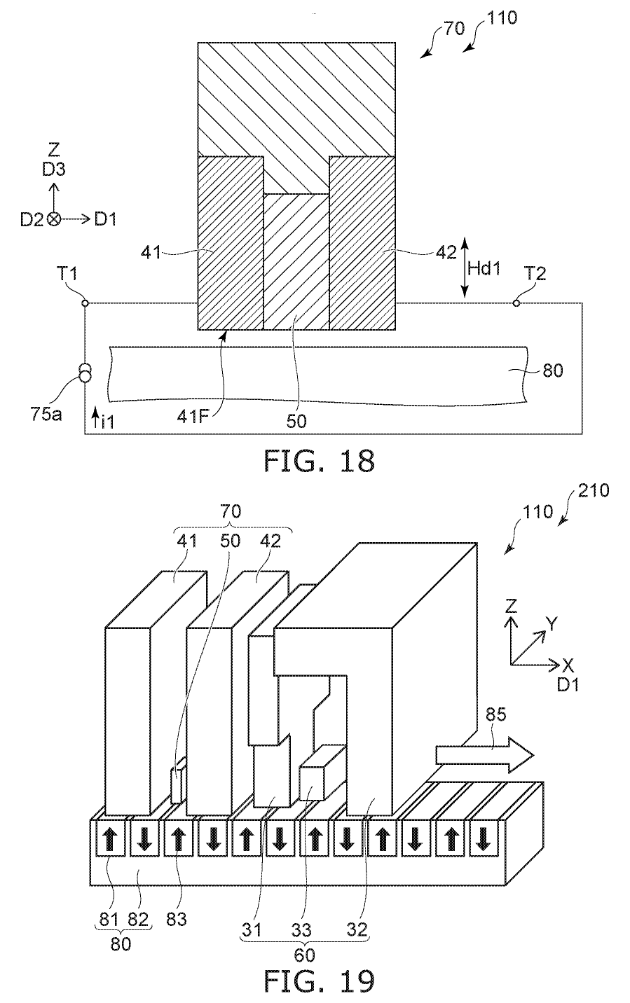

FIG. 18 is a schematic cross-sectional view illustrating an application of the magnetic sensor according to the embodiment.

As shown in FIG. 18, the magnetic sensor 70 (or any of the magnetic sensors described above) may be applied to a magnetic head 110. The direction from the magnetic recording medium 80 to the magnetic head 110 may be along the third direction D3. For example, the controller 75 may include a current source 75a provided between the first conductive portion 41 and the second conductive portion 42. The magnetic field from the magnetic recording medium 80 corresponds to the target magnetic field Hd1. The magnetic recording medium 80 moves relative to the magnetic head 110 in a plane crossing the third direction D3.

FIG. 19 is a schematic perspective view illustrating a magnetic recording device according to an embodiment.

As shown in FIG. 19, a magnetic recording device 210 according to an embodiment includes the magnetic head 110 including the magnetic sensor 70 according to the embodiment (or another magnetic sensor described above), and the magnetic recording medium 80. The target magnetic field Hd1 corresponds to information recorded on the magnetic recording medium 80. The magnetic sensor 70 corresponds to a reproducing section.

The magnetic head 110 may include a recording section 60. Information is recorded on the magnetic recording medium 80 by the recording section 60. The information recorded on the magnetic recording medium 80 is reproduced by the magnetic sensor 70.

The magnetic recording medium 80 includes, for example, a medium substrate 82 and a magnetic recording layer 81 provided on the medium substrate 82. The magnetization 83 of the magnetic recording layer 81 is controlled by the recording section 60. The recording section 60 includes, for example, a first magnetic pole 31 and a second magnetic pole 32. The first magnetic pole 31 is, for example, a main magnetic pole. The second magnetic pole 32 is, for example, a trailing shield. The recording section 60 may include a recording section element 33. The recording section element 33 may include a magnetic field control element or a high-frequency oscillation element. The recording section element 33 may be omitted.

As shown in FIG. 19, the magnetic recording medium 80 moves relative to the magnetic head 110 in the medium movement direction 85. The magnetic head 110 controls information corresponding to the magnetization 83 of the magnetic recording layer 81 at any position. The magnetic head 110 reproduces information corresponding to the magnetization 83 of the magnetic recording layer 81 at any position.

In this example, the first direction D1 from the first conductive portion 41 to the second conductive portion 42 is along an X-axis direction. The X-axis direction is along the down-track direction.

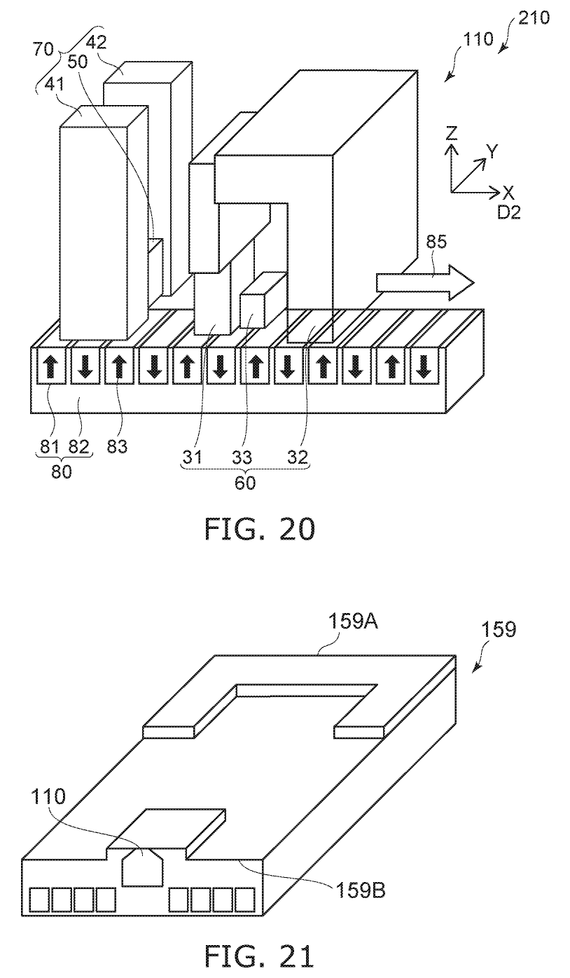

FIG. 20 is a schematic perspective view illustrating a magnetic recording device according to the embodiment.

In the example shown in FIG. 20, the second direction D2 is along the X-axis direction. The X-axis direction is along the down-track direction.

FIG. 21 is a schematic perspective view illustrating a part of a magnetic recording device according to an embodiment.

FIG. 21 illustrates a head slider.

The magnetic head 110 is provided on a head slider 159. The head slider 159 includes, for example, Al₂O₃/TiC. The head slider 159 moves relative to the magnetic recording medium while floating above or in contact with the magnetic recording medium.

The head slider 159 has, for example, an air inflow side 159A and an air outflow side 159B. The magnetic head 110 is disposed on the side of the air outflow side 159B of the head slider 159. As a result, the magnetic head 110 moves relative to the magnetic recording medium while floating above or in contact with the magnetic recording medium.

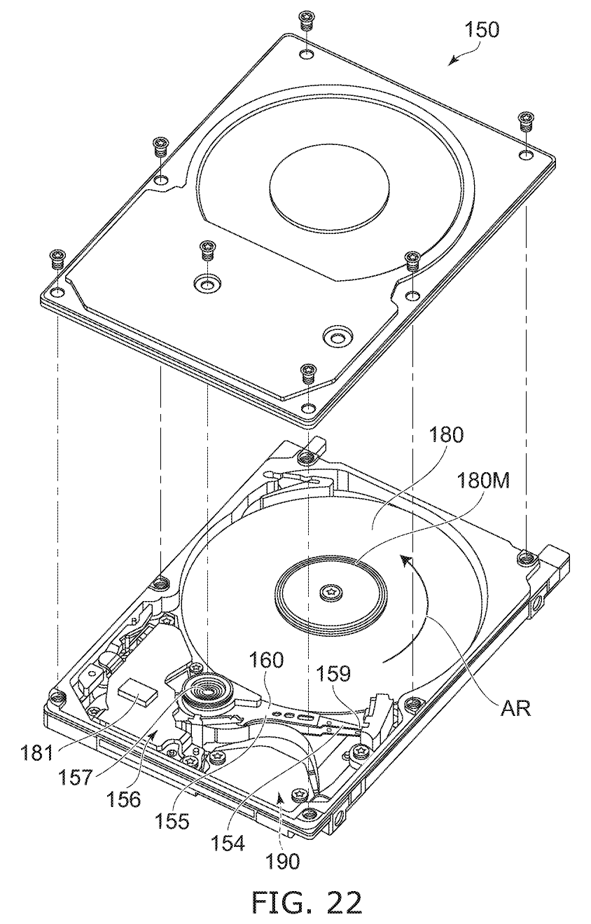

FIG. 22 is a schematic perspective view illustrating the magnetic recording device according to the embodiment.

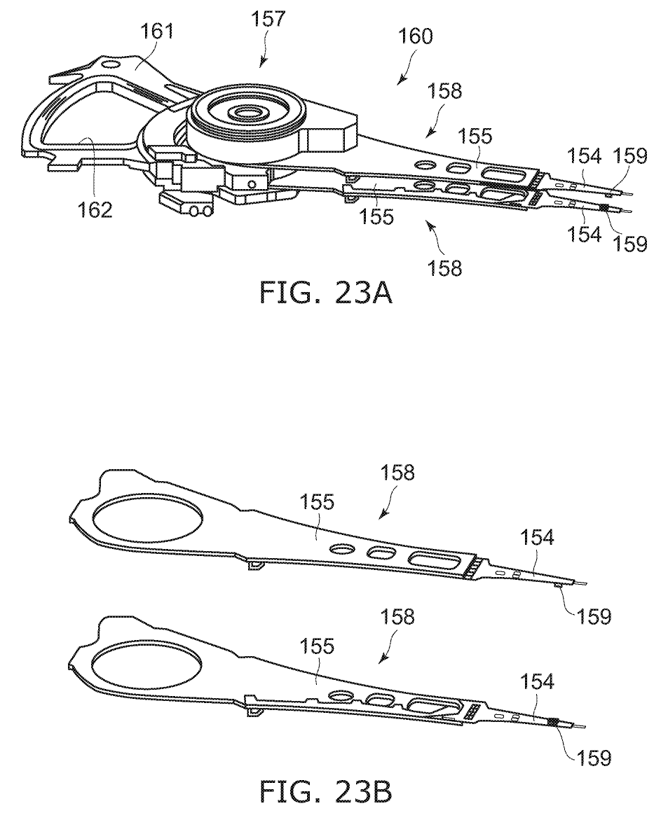

FIGS. 23A and 23B are schematic perspective views illustrating a part of the magnetic recording device according to the embodiment.

As shown in FIG. 22, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the plurality of recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 23A is an enlarged perspective view of the head stacked body assembly 160, illustrating the configuration of a part of the magnetic recording device.

FIG. 23B is a perspective view illustrating the magnetic head assembly (head gimbal assembly: HGA) 158 that forms part of the head stacked body assembly 160.

As shown in FIG. 23A, the head stacked body assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 23B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to a plurality of electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### Technical proposal 1

A magnetic sensor, comprising:

a first conductive portion;

a second conductive portion;

a sensor portion;

a temperature control element; and

a controller,

the sensor portion including a first magnetic member provided between the first conductive portion and the second conductive portion,

a direction from the temperature control element to the sensor portion including a component of a second direction crossing a first direction from the first conductive portion to the second conductive portion,

the controller being configured to change a temperature of the temperature control element.

### Technical proposal 2

The magnetic sensor according to Technical proposal 1, wherein

the controller is configured to detect a first signal generated between the first conductive portion and the second conductive portion, and

the first signal changes according to a target magnetic field.

### Technical proposal 3

The magnetic sensor according to Technical proposal 2, wherein

the first signal changes according to a component of the target magnetic field in a third direction, and

the third direction crosses a plane including the first direction and the second direction.

### Technical proposal 4

The magnetic sensor according to Technical proposal 3, wherein

the first magnetic member includes at least one selected from the group consisting of Co, Co₂MnGa, Co₂MnAl, Co₃Sn₂S₂, CoFeB, FePt, Fe, FePd, FeGa, FeAl, MnGa, Mn₂Ga, Mn₃Sn, Mn₃Ge, Mn₃Ga, Ni, NiPd, NiFe, Nd₅Mn₂O₇, RuO₂, MnTe, CrSb, FeSb₂, KRu₄O₈, and Mn₅Si₃.

### Technical proposal 5

The magnetic sensor according to any one of Technical proposals 1-4, wherein

the sensor portion further includes a first structure and a second structure,

a first magnetic member position in the second direction of the first magnetic member is between a first structure position in the second direction of the first structure and a second structure position in the second direction of the second structure, and

a first thermal conductivity of the first structure is different from a second thermal conductivity of the second structure.

### Technical proposal 6

The magnetic sensor according to any one of Technical proposals 1-5, wherein

the temperature control element includes a conductive member or a Peltier element.

### Technical proposal 7

A magnetic sensor, comprising:

a first conductive portion;

a second conductive portion;

a sensor portion;

a temperature control element; and

a controller,

the sensor portion includes:

a first magnetic member provided between the first conductive portion and the second conductive portion,

a first structure, and

a second structure,

a second direction from the first structure to the second structure crossing a first direction from the first conductive portion to the second conductive portion,

a first magnetic member position in the second direction of the first magnetic member being between a first structure position in the second direction of the first structure and a second structure position in the second direction of the second structure,

a first thermal conductivity of the first structure being different from a second thermal conductivity of the second structure, and

the controller being configured to change a temperature of the temperature control element.

### Technical proposal 8

The magnetic sensor according to Technical proposal 7, wherein

a direction from the sensor portion to the temperature control element includes at least one component of the first direction and a third direction, and

the third direction crosses a plane including the first direction and the second direction.

### Technical proposal 9

The magnetic sensor according to Technical proposal 8, wherein

the controller is configured to detect a first signal generated between the first conductive portion and the second conductive portion, and

the first signal changes according to a target magnetic field.

### Technical proposal 10

The magnetic sensor according to Technical proposal 9, wherein

the first signal changes according to a component of the target magnetic field in a third direction, and

the third direction crosses a plane including the first direction and the second direction.

### Technical proposal 11

The magnetic sensor according to any one of Technical proposals 7-10, wherein

the first magnetic member includes at least one selected from the group consisting of Co, Co₂MnGa, Co₂MnAl, Co₃Sn₂S₂, CoFeB, FePt, Fe, FePd, FeGa, FeAl, MnGa, Mn₂Ga, Mn₃Sn, Mn₃Ge, Mn₃Ga, Ni, NiPd, NiFe, Nd₅Mn₂O₇, RuO₂, MnTe, CrSb, FeSb₂, KRu₄O₈, and Mn₅Si₃.

### Technical proposal 12

The magnetic sensor according to any one of Technical proposals 7-11, wherein

the temperature control element includes a conductive member or a Peltier element.

### Technical proposal 13

A magnetic sensor, comprising:

a first conductive portion;

a second conductive portion; and

a sensor portion,

the sensor portion including:

a first magnetic member provided between the first conductive portion and the second conductive portion,

a first structure, and

a second structure, a second direction from the first structure to the second structure crossing a first direction from the first conductive portion to the second conductive portion,

a first magnetic member position in the second direction of the first magnetic member being between a first structure position in the second direction of the first structure and a second structure position in the second direction of the second structure, and

a first thermal conductivity of the first structure being different from a second thermal conductivity of the second structure.

### Technical proposal 14

The magnetic sensor according to Technical proposal 13, further comprising:

a controller,

the controller being configured to detect a first signal generated between the first conductive portion and the second conductive portion, and

the first signal being configured to change according to a target magnetic field.

### Technical proposal 15

The magnetic sensor according to Technical proposal 14, wherein

the first signal changes according to a component of the target magnetic field in a third direction, and

the third direction crosse a plane including the first direction and the second direction.

### Technical proposal 16

The magnetic sensor according to any one of Technical proposals 13-15, wherein

the first magnetic member includes at least one selected from the group consisting of Co, Co₂MnGa, Co₂MnAl, Co₃Sn₂S₂, CoFeB, FePt, Fe, FePd, FeGa, FeAl, MnGa, Mn₂Ga, Mn₃Sn, Mn₃Ge, Mn₃Ga, Ni, NiPd, NiFe, Nd₅Mn₂O₇, RuO₂, MnTe, CrSb, FeSb₂, KRu₄O₈, and Mn₅Si₃.

### Technical proposal 17

A magnetic sensor, comprising:

a first conductive portion;

a second conductive portion;

a first magnetic member provided between the first conductive portion and the second conductive portion, the first magnetic member including a first portion and a second portion, a second direction from the first portion to the second portion crossing a first direction from the first conductive portion to the second conductive portion;

a first terminal electrically connected to the first conductive portion;

a second terminal electrically connected to the second conductive portion;

a third terminal electrically connected to the first portion; and

a fourth terminal electrically connected to the second portion; and

a controller,

the controller being configured to detect a first signal generated between the first terminal and the second terminal and a second signal generated between the third terminal and the fourth terminal, and

the first signal and the second signal being configured to change according to a target magnetic field.

### Technical proposal 18

A magnetic recording device, comprising:

a magnetic head including the magnetic sensor according to any one of Technical proposals 3, 10, and 15; and

a magnetic recording medium,

the target magnetic field corresponds to information recorded on the magnetic recording medium.

### Technical proposal 19

The magnetic recording device according to Technical proposal 18, wherein

a direction from the magnetic recording medium to the magnetic sensor is along the third direction.

### Technical proposal 20

The magnetic recording device according to Technical proposal 19, wherein

the first direction or the second direction is aligned with the down-track direction of the magnetic recording medium.

According to the embodiment, a magnetic sensor and a magnetic recording device can be provided that can improve the characteristics.

In the specification of the application, "perpendicular" and "parallel" refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic sensors and magnetic recording devices such as conductive portions, magnetic members, structures, magnetic recording mediums, magnetic heads, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic sensors and all magnetic recording devices practicable by an appropriate design modification by one skilled in the art based on the magnetic sensors and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic sensor, comprising:
a first conductive portion;
a second conductive portion;
a sensor portion;
a temperature control element; and
a controller,
the sensor portion including a first magnetic member provided between the first conductive portion and the second conductive portion,
a direction from the temperature control element to the sensor portion including a component of a second direction crossing a first direction from the first conductive portion to the second conductive portion,
the controller being configured to change a temperature of the temperature control element.

2. The magnetic sensor according to claim 1, wherein
the controller is configured to detect a first signal generated between the first conductive portion and the second conductive portion, and
the first signal changes according to a target magnetic field.

3. The magnetic sensor according to claim 2, wherein
the first signal changes according to a component of the target magnetic field in a third direction, and
the third direction crosses a plane including the first direction and the second direction.

4. The magnetic sensor according to claim 3, wherein
the first magnetic member includes at least one selected from the group consisting of Co, Co₂MnGa, Co₂MnAl, Co₃Sn₂S₂, CoFeB, FePt, Fe, FePd, FeGa, FeAl, MnGa, Mn₂Ga, Mn₃Sn, Mn₃Ge, Mn₃Ga, Ni, NiPd, NiFe, Nd₅Mn₂O₇ RuO₂, MnTe, CrSb, FeSb₂, KRu₄O₈, and Mn₅Si₃.

5. The magnetic sensor according to claim 1, wherein
the sensor portion further includes a first structure and a second structure,
a first magnetic member position in the second direction of the first magnetic member is between a first structure position in the second direction of the first structure and a second structure position in the second direction of the second structure, and
a first thermal conductivity of the first structure is different from a second thermal conductivity of the second structure.

6. The magnetic sensor according to claim 1, wherein
the temperature control element includes a conductive member or a Peltier element.

7. A magnetic sensor, comprising:
a first conductive portion;
a second conductive portion;
a sensor portion;
a temperature control element; and
a controller,
the sensor portion includes:
a first magnetic member provided between the first conductive portion and the second conductive portion,
a first structure, and
a second structure,
a second direction from the first structure to the second structure crossing a first direction from the first conductive portion to the second conductive portion,
a first magnetic member position in the second direction of the first magnetic member being between a first structure position in the second direction of the first structure and a second structure position in the second direction of the second structure,
a first thermal conductivity of the first structure being different from a second thermal conductivity of the second structure, and
the controller being configured to change a temperature of the temperature control element.

8. The magnetic sensor according to claim 7, wherein
a direction from the sensor portion to the temperature control element includes at least one component of the first direction and a third direction, and
the third direction crosses a plane including the first direction and the second direction.

9. The magnetic sensor according to claim 8, wherein
the controller is configured to detect a first signal generated between the first conductive portion and the second conductive portion, and
the first signal changes according to a target magnetic field.

10. The magnetic sensor according to claim 9, wherein
the first signal changes according to a component of the target magnetic field in a third direction, and
the third direction crosses a plane including the first direction and the second direction.

11. The magnetic sensor according to claim 7, wherein
the first magnetic member includes at least one selected from the group consisting of Co, Co₂MnGa, Co₂MnAl, Co₃Sn₂S₂,CoFeB, FePt, Fe, FePd, FeGa, FeAl, MnGa, Mn₂Ga, Mn₃Sn, Mn₃Ge, Mn₃Ga, Ni, NiPd, NiFe, Nd₅Mn₂O₇,RuO₂,MnTe, CrSb, FeSb₂,KRu₄O₈ and Mn₅Si₃.

12. The magnetic sensor according to claim 7, wherein
the temperature control element includes a conductive member or a Peltier element.

13. A magnetic sensor, comprising:
a first conductive portion;
a second conductive portion; and
a sensor portion,
the sensor portion including:
a first magnetic member provided between the first conductive portion and the second conductive portion,
a first structure, and
a second structure, a second direction from the first structure to the second structure crossing a first direction from the first conductive portion to the second conductive portion,
a first magnetic member position in the second direction of the first magnetic member being between a first structure position in the second direction of the first structure and a second structure position in the second direction of the second structure, and
a first thermal conductivity of the first structure being different from a second thermal conductivity of the second structure.

14. The magnetic sensor according to claim 13, further comprising:
a controller,
the controller being configured to detect a first signal generated between the first conductive portion and the second conductive portion, and
the first signal being configured to change according to a target magnetic field.

15. The magnetic sensor according to claim 14, wherein
the first signal changes according to a component of the target magnetic field in a third direction, and
the third direction crosse a plane including the first direction and the second direction.

16. The magnetic sensor according to claim 13, wherein
the first magnetic member includes at least one selected from the group consisting of Co, Co₂MnGa, Co₂MnAl, Co₃Sn₂S₂,CoFeB, FePt, Fe, FePd, FeGa, FeAl, MnGa, Mn₂Ga, Mn₃Sn, Mn₃Ge, Mn₃Ga, Ni, NiPd, NiFe, Nd₅Mn₂O₇, RuO₂,MnTe, CrSb, FeSb₂,KRu₄O₈ and Mn₅Si₃.

17. A magnetic sensor, comprising:
a first conductive portion;
a second conductive portion;
a first magnetic member provided between the first conductive portion and the second conductive portion, the first magnetic member including a first portion and a second portion, a second direction from the first portion to the second portion crossing a first direction from the first conductive portion to the second conductive portion;
a first terminal electrically connected to the first conductive portion;
a second terminal electrically connected to the second conductive portion;
a third terminal electrically connected to the first portion; and
a fourth terminal electrically connected to the second portion; and
a controller,
the controller being configured to detect a first signal generated between the first terminal and the second terminal and a second signal generated between the third terminal and the fourth terminal, and
the first signal and the second signal being configured to change according to a target magnetic field.

18. A magnetic recording device, comprising:
a magnetic head including the magnetic sensor according to claim 3; and
a magnetic recording medium,
the target magnetic field corresponds to information recorded on the magnetic recording medium.

19. The magnetic recording device according to claim 18, wherein
a direction from the magnetic recording medium to the magnetic sensor is along the third direction.

20. The magnetic recording device according to claim 19, wherein
the first direction or the second direction is aligned with the down-track direction of the magnetic recording medium.
